(19) United States
(12) Patent Application Publication
(10) Pub. No.: US 2008/0082222 A1
(43) Pub. Date: Apr. 3, 2008

(54) REAL-TIME CONCURRENT PROCESSING SYSTEM AND METHOD OF TELEMETRY DATA AND SIMULATED TELEMETRY DATA

(75) Inventors: Myung-Ja Kim, Daejon (KR); Won-Chan Jung, Daejon (KR); Jae-Hoon Kim, Daejon (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Daejon (KR)

(21) Appl. No.: 11/760,510

(22) Filed: Jun. 8, 2007

(30) Foreign Application Priority Data
Sep. 28, 2006 (KR) 10-2006-0094982

(51) Int. Cl. G05D 1/00; G06F 17/30; G06F 17/40

(52) U.S. Cl. 701/3; 707/104.1

(57) ABSTRACT

Provided are a real-time concurrent processing system and a method of telemetry data and simulated telemetry data. The real-time concurrent processing system includes a first operation unit connected with a satellite based on a configuration file, for receiving the telemetry data from the satellite and processing the telemetry data based on the configuration file; and second operation unit for processing the telemetry data received from the satellite based on the configuration file and processing simulated telemetry data received from a simulator based on the configuration file.

### CROSS-REFERENCE TO RELATED APPLICATIONS

The present invention claims priority of Korean Patent Application No. 10-2006-0094982, filed on Sep. 28, 2006, which is incorporated herein by reference.

### BACKGROUND OF THE INVENTION

1. Field of the Invention

The present invention relates to a real-time concurrent processing system and method of telemetry data and simulated telemetry data; and, more particularly, to a real-time concurrent processing system and method of telemetry data and simulated telemetry data that minimizes effect of simulation operation on the control of a satellite by processing the telemetry data based on a configuration file in a first operating unit and concurrently processing the telemetry data and the simulated telemetry data in a second operating unit.

2. Description of Related Art

Generally, a geostationary earth orbit satellite (GEO satellite) acts 24 hours and periodically transmits telemetry data representing the state of the satellite to the ground. Here, a real-time processing system of a satellite ground control system (SGCS) has to process the telemetry data received from the satellite without loss and to provide processed telemetry data to users in real-time.

The conventional ground control system which controls the geostationary earth orbit satellite processes the telemetry data of the GEO satellite. Also, the ground control system performs a simulation for satellite operations. The simulation is performed by an independent simulation system from the ground control system.

Therefore, the independent simulation system has to have separate software for the simulation. In addition, the user performs test for simulating the state of the satellite by connecting with a simulator if necessary. When the simulation is performed by connecting with the simulator, it affects on receiving and processing the telemetry data from the satellite.

### SUMMARY OF THE INVENTION

An embodiment of the present invention is directed to provide a real-time concurrent processing system and method of telemetry data and simulated telemetry data that minimizes effect of simulation operation on the control of a satellite by processing the telemetry data based on a configuration file in a first operating unit and concurrently processing the telemetry data and the simulated telemetry data in a second operating unit.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an aspect of the present invention, there is provided a real-time concurrent processing system of telemetry data and simulated telemetry data, including: a first operation unit connected with a satellite based on a configuration file, for receiving the telemetry data from the satellite and processing the telemetry data based on the configuration file; and second operation unit for processing the telemetry data received from the satellite based on the configuration file and processing simulated telemetry data received from a simulator based on the configuration file.

In accordance with another aspect of the present invention, there is provided a real-time concurrent processing method of telemetry data and simulated telemetry data, including the steps of: a) connecting with a satellite or a simulator based on a configuration file by reading source information from the configuration file; b) receiving the telemetry data from the satellite or the simulated telemetry data from the simulator; c) processing the telemetry data based on the configuration file or concurrently processing the telemetry data and the simulated telemetry data; and d) storing the processed telemetry data to a predetermined location based on the configuration file.

### BRIEF DESCRIPTION OF THE DRAWINGS

FIG. 1 is a diagram illustrating a satellite ground control system to which the present invention is applied.

FIG. 2 is a diagram illustrating a real-time concurrent processing system to which the present invention is applied.

FIG. 3 is a diagram illustrating a real-time concurrent processing system of a telemetry data and a simulated telemetry data in accordance with an embodiment of the present invention.

FIG. 4 is a flowchart showing a real-time current processing method of a telemetry data and a simulated telemetry data in accordance with an embodiment of the present invention.

### DESCRIPTION OF SPECIFIC EMBODIMENTS

The advantages, features and aspects of the invention will become apparent from the following description of the embodiments with reference to the accompanying drawings, which is set forth hereinafter.

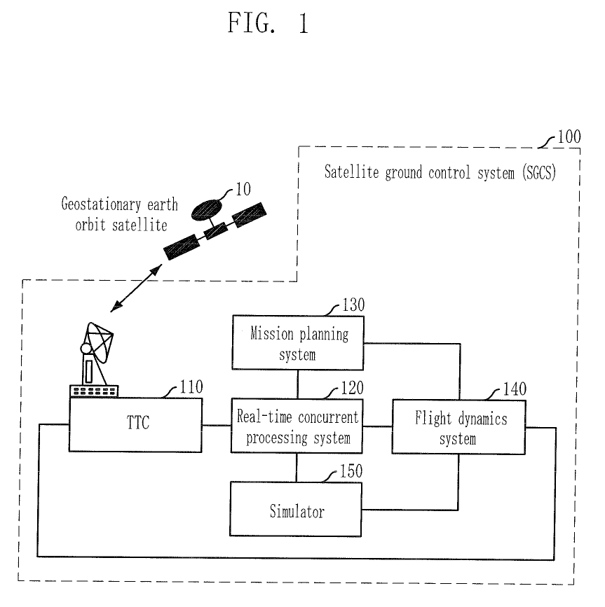

FIG. 1 is a diagram illustrating a satellite ground control system to which the present invention is applied.

As shown in FIG. 1, the satellite ground control system (SGCS) 110 includes a telemetry, tracking and command system (TTC) 110, a real-time concurrent processing system 120, a mission planning system 130, a flight dynamics system 140 and a simulator 150.

The TTC 110 transmits a telecommand to a geostationary earth orbit (GEO) satellite 10. Then, the TTC 110 receives telemetry data corresponding to the previous transmitted telecommand from the GEO satellite 10.

The telecommand is generated in the real-time concurrent processing system 120 and forwarded into the TTC 110. Also, the real-time concurrent processing system 120 receives the telemetry data from the TTC 110, processes the telemetry data based on a configuration file received from a user and provides the state of the satellite to the user.

The mission planning system 130 gathers mission requests from outside requester, performs a mission scheduling and transmits the mission scheduling to the real-time concurrent processing system 120.

The flight dynamics system 140 performs operations related to a flight dynamics of the satellite.

The simulator 150 simulates various systems of the satellite based on the telecommand for simulation from real-time concurrent processing system 120.

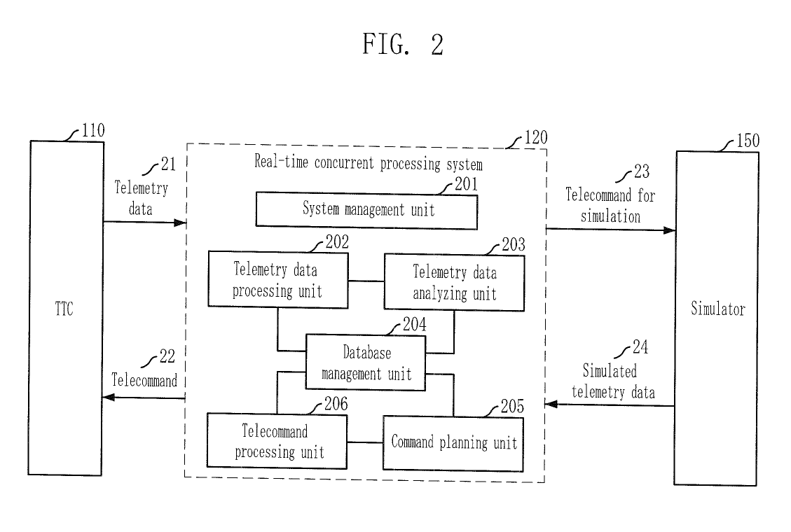

FIG. 2 is a diagram illustrating a real-time concurrent processing system to which the present invention is applied.

As shown in FIG. 2, the real-time concurrent processing system 120 includes a system management unit 201, a telemetry data processing unit 202, a telemetry data analyzing unit 203, a database management unit 204, a command planning unit 205 and a telecommand processing unit 206.

Here, the real-time concurrent processing system 120 receives the telemetry data 21 of the satellite from the TTC 110 or transmits the telecommand 22 to the TTC 110. Also, the real-time concurrent processing system 120 connects with the simulator 150, transmits the telecommand for simulation 23 to the simulator 150 and receives simulated telemetry data 24 from the simulator 150 in order to simulate the state of the satellite.

In more detail, the command planning unit 205 plans the telecommand for satellite operations and the telecommand for simulation.

The telecommand processing unit 206 generates the telecommand for satellite operations and the telecommand for simulation according to the plans of the command planning unit 205 and transmits them to corresponding destination, i.e. the satellite or the simulator.

The telemetry data analyzing unit 203 receives the corresponding the telemetry data from the source connected based on a configuration file received from the user. That is, the telemetry data analyzing unit 203 receives and analyzes the telemetry data from the satellite or the simulated telemetry data from the simulator 150 based on the configuration file.

The telemetry data processing unit 202 processes the telemetry data according to the configuration file based on the analysis result of the telemetry data analyzing unit 203.

The database management unit 204 provides processing result of the telemetry processing unit 202 to the user, and stores the telemetry data to the predetermined location based on the configuration file. Here, the configuration file includes source information of the telemetry data, processing information of the telemetry data and storing location information of the telemetry data.

The system management unit 201 manages the total elements of the real-time concurrent processing system as mentioned above.

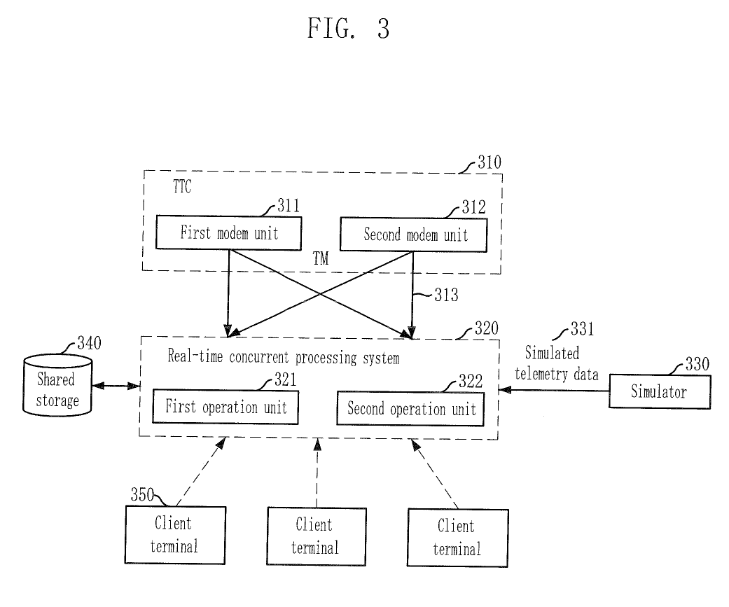

FIG. 3 is a diagram illustrating a real-time concurrent processing system of a telemetry data and a simulated telemetry data in accordance with an embodiment of the present invention.

As shown in FIG. 3, the real-time concurrent processing system 320 of the telemetry data and the simulated telemetry data in accordance with the present invention includes a first operation unit 321 and a second operation unit 322. Here, the TTC 310 includes a first modem unit 311 and a second modem unit 312.

Here, the first operation unit 321 and the second operation unit 322 include the same elements as the elements of the real-time processing system 120 in FIG. 2. Hereinafter, the operations of the first operation unit 321 and the second operation unit 322 will be described in detail.

The first modem unit 311 and the second modem unit 312 of the TTC 310 transmit the same telemetry data 313 to the first operation unit 321 and the second operation unit 322 of the real-time concurrent processing system 320, respectively.

The real-time concurrent processing system 320 has duplicated structure to simulate the GEO satellite. In general operation, the first operation unit 321 and the second operation unit 322 of the real-time concurrent processing system 320 process the telemetry data. However, when the simulation of the satellite is needed, simulated telemetry data through the simulation and the telemetry data are concurrently processed.

That is, the real-time concurrent processing system 320 is connected with a simulator 330, receives and processes the simulated telemetry data from the simulator 330 when the simulation is performed. Meanwhile, the first operation unit 321 and the second operation unit 322 identically process the telemetry data received from the satellite. Also, the second operation unit 322 is connected with the simulator 330, receives and processes the simulated telemetry data from the simulator 330.

Also, the first operation unit 321 and the second operation unit 322 of the real-time concurrent processing system 320 can concurrently process telemetry data and the simulated telemetry data. However, in actual operation, the first operation unit 321 of the real-time concurrent processing system 320 only processes the telemetry data of the satellite, and the second operation unit 322 processes telemetry data of the satellite and the simulated telemetry data. Because it minimizes effect of the simulated telemetry data processing on the telemetry data processing in the first operation unit 321 for controlling the geostationary earth orbit satellite.

Then, the real-time concurrent processing system 320 provides the processed telemetry data of the satellite to the users through a client terminal 350. Also, the real-time concurrent processing system 320 stores the received telemetry data of the satellite to a shared storage 340.

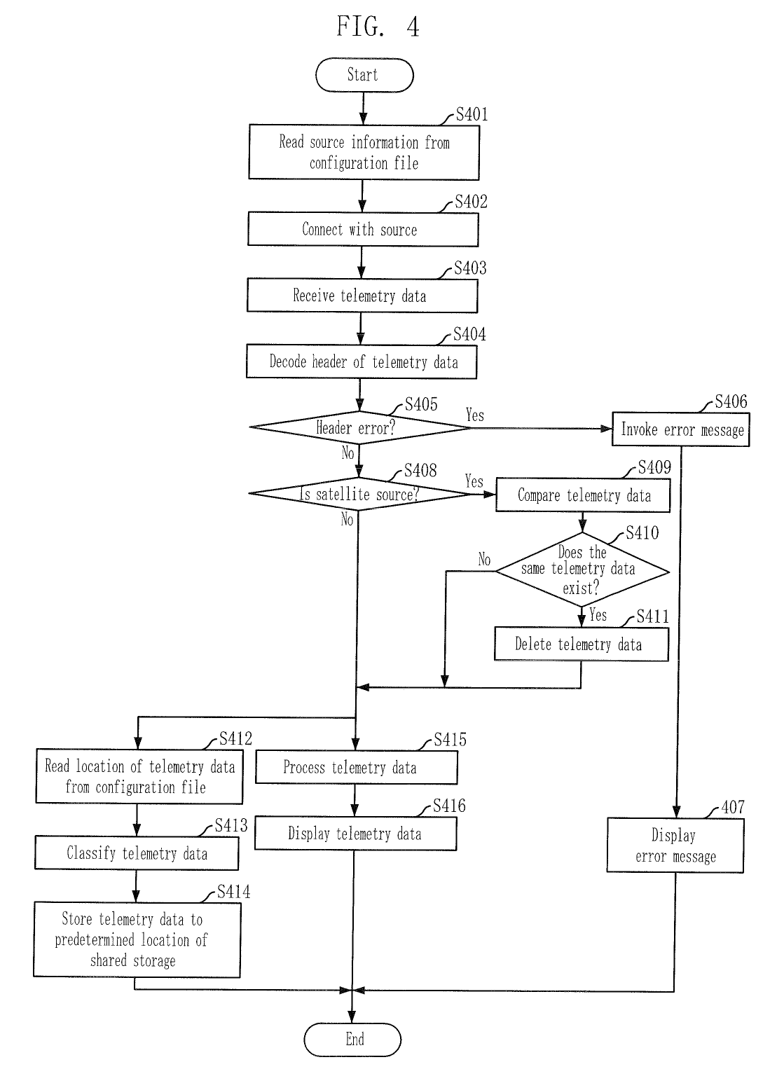

FIG. 4 is a flowchart showing a real-time concurrent processing method of a telemetry data and a simulated telemetry data in accordance with an embodiment of the present invention.

First, the real-time concurrent processing system 320 reads source information of the telemetry data should be received by the current process, from a configuration file at step S401. Then, the real-time concurrent processing system 320 connects with a source of the telemetry data based on the configuration file at step S402.

After completing the source connection, at step S403, the real-time concurrent processing system 320 receives the telemetry data from the corresponding source, i.e., the satellite or the simulator. The header of the telemetry data frame is decoded at step S404, it is determined whether or not error exists in the current frame at step S405. If the error exists in the current frame, an error message is invoked at step S406. Then, the error message is displayed to the user at step S407 and the next frame is received.

On the other hand, if the error does not exist in the current frame at step S405, it is examined that the source read from the configuration file is the satellite at step S408. If the source is the satellite, the telemetry data are compared at step S409, and it is determined whether no not the same telemetry data exists at step S410. If the same telemetry data exists, one of the same telemetry data is deleted at step S411, and goes to the step S415. Because the first modem unit 311 and the second modem unit 312 concurrently receive same telemetry data from the satellite, one of them should be deleted. Meanwhile, the same telemetry data does not exist, and goes to the step S415.

Then, the real-time concurrent processing system 320 processes the telemetry data base on the configuration file at step S415, the telemetry data is displayed to the user at step S416. After the real-time concurrent processing system 320 process one telemetry data frame, and receives the next telemetry data frame.

Also, the real-time concurrent processing system 320 processes telemetry data and stores the telemetry data to the predetermined location based on the configuration file concurrently. That is, the real-time concurrent processing system 320 reads storing location information of the telemetry data from the configuration file at step S412. Then, the telemetry data are classified according to date included in the telemetry data at step S413 and stored to the predetermined location of the shared storage at step S414. Here, database management unit may classify and store the telemetry data and the simulated telemetry data on different directories.

In the present invention, the telemetry data received from the geostationary earth orbit satellite and the simulated telemetry data generated by simulation can be divided and processed based on the configuration file including the source information, processing information of the telemetry data and storing location information of the telemetry data.

Also, in the present invention, the first operation unit 321 of the real-time concurrent processing system 320 processes the telemetry data and the second operation unit 322 concurrently processes the telemetry data of the satellite and the simulated telemetry data, so that loads of a primary system can be reduced and the loss of the telemetry data received form the geostationary earth orbit satellite can be prevented by automatically switching from the primary system into a backup system when an errors occurs in the primary system.

That is, the present invention performs the simulation by connecting the simulator without an effect on the control of the geostationary earth orbit satellite.

The above described method according to the present invention can be embodied as a program and be stored on a computer readable recording medium. The computer readable recording medium is any data storage device that can store data which can be read by the computer system. The computer readable recording medium includes a read-only memory (ROM), a random-access memory (RAM), a CD-ROM, a floppy disk, a hard disk and an optical magnetic disk.

While the present invention has been described with respect to the specific embodiments, it will be apparent to those skilled in the art that various changes and modifications may be made without departing from the spirit and scope of the invention as defined in the following claims.

What is claimed is:

1. A real-time concurrent processing system of telemetry data and simulated telemetry data, comprising:
a first operation means connected with a satellite based on a configuration file, for receiving the telemetry data from the satellite and processing the telemetry data based on the configuration file; and
a second operation means for processing the telemetry data received from the satellite based on the configuration file and processing simulated telemetry data received from a simulator based on the configuration file.

2. The real-time concurrent processing system of claim 1, wherein the first operation means includes:
a first command planning means for planning a telecommand for satellite operations;
a first telecommand processing means for generating the telecommand for satellite operations planned in the first command planning means and transmitting the telecommand to the satellite;
a first telemetry data analyzing means for connecting with the satellite based on the configuration file and analyzing the telemetry data received from the satellite;
a first telemetry data processing means for processing the telemetry data based on analysis result of the first telemetry data analyzing means; and
a first database management means for storing the telemetry data to a predetermined location based on the configuration file.

3. The real-time concurrent processing system of claim 2, wherein the second operation means includes:
a second command planning means for planning a telecommand for satellite operations and a telecommand for simulation;
a second telecommand processing means for generating the telecommand for satellite operations and the telecommand for the simulation planned in the second command planning means and transmitting the telecommand to the satellite or a simulator;
a second telemetry data analyzing means for analyzing the telemetry data and a simulated telemetry data received from the satellite or the simulator based on the configuration file;
a second telemetry data processing means for processing the telemetry data and the simulated telemetry data based on analysis result of the second telemetry data analyzing means; and
a second database management means for storing the telemetry data and the simulated telemetry data to a predetermined location based on the configuration file.

4. The real-time concurrent processing system of claim 3, wherein the configuration file includes source information of the telemetry data, processing information of the telemetry data and storing location information of the telemetry data.

5. The real-time concurrent processing system of claim 4, wherein the second database management means classifies and stores the telemetry data and the simulated telemetry data on different directories.

6. The real-time concurrent processing system of claim 1, wherein the second operation means is switched from the first operation means and receives the telemetry data in order to prevent loss of the telemetry data when an error occurs in the first operation means.

7. A real-time concurrent processing method of telemetry data and simulated telemetry data, comprising the steps of:
a) connecting with a satellite or a simulator based on a configuration file by reading source information from the configuration file;
b) receiving the telemetry data from the satellite or the simulated telemetry data from the simulator;
c) processing the telemetry data based on the configuration file or concurrently processing the telemetry data and the simulated telemetry data; and
d) storing the processed telemetry data to a predetermined location based on the configuration file.

8. The real-time concurrent processing method of claim 7, wherein the telemetry data is switched and received to prevent loss of the telemetry data when an error occurs in the step b).

9. The real-time concurrent processing method of claim 8, wherein, if the same telemetry data exists, one of the same telemetry data is deleted and a remained telemetry data is processed in the step c) 10. The real-time concurrent processing method of claim 7, wherein the step d) includes the steps of:
d1) reading a stroing location of the telemetry data from the configuration file;
d2) classifying the telemetry data according to date included in the telemetry data; and
d3) storing the telemetry data on the predetermined location.
